(19) United States
(12) Patent Application Publication
(10) Pub. No.: US 2009/0153048 A1
(43) Pub. Date: Jun. 18, 2009

(54) HIGH-PRESSURE GAS DISCHARGE LAMP

(75) Inventor: Holger Monch, Vaals (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/577,741

(22) PCT Filed: Oct. 20, 2005
(86) PCT No.: PCT/IB05/53432

§ 371 Date: Feb. 27, 2009

(30) Foreign Application Priority Data
Oct. 26, 2004 (EP) 04105290.3

(51) Int. Cl. H01J 61/12

(52) U.S. Cl. 313/570

(57) ABSTRACT

A description is given of a high-pressure gas discharge lamp (HID lamp) which comprises an at least essentially mercury-free discharge gas and is suitable and/or intended for use in projection displays, in particular in the form of a short-arc lamp. A lamp voltage and efficiency which are comparable to mercury lamps are essentially achieved in that the discharge gas comprises a noble gas and also zinc as a voltage gradient former and light generator, wherein the pressure of the zinc in the gas phase is preferably approximately 30 bar in the operating state of the lamp. An evaporation which is necessary to achieve this pressure is made possible by increasing in particular the lowest temperatures in the discharge vessel. Various measures are proposed for increasing the temperature.

The invention relates to a high-pressure gas discharge lamp which comprises an at least essentially mercury-free discharge gas and is suitable and/or intended for use in projection displays, in particular in the form of a short-arc lamp.

Conventional high-pressure gas discharge lamps generally comprise, in addition to a starter gas (e.g. a noble gas), firstly a discharge gas (e.g. a metal halide such as sodium iodide or scandium iodide), which is the actual light-emitting material (light generator), and secondly a voltage gradient former or a buffer gas (e.g. mercury) which generally has to have a relatively high vapor pressure compared to the starter gas and the light generator and essentially has the function of increasing the optical efficiency and the lamp voltage of the lamp.

On account of their good properties in terms of light technology, lamps of this type are widely known, and they are used in particular in projection displays such as LCD projectors and also increasingly in automotive technology. However, for these and other applications, there is also an environmental protection requirement that the lamps do not contain any mercury.

The problems associated with an absence of mercury (which are explicitly described for example in US 2003/0020409 A1) essentially consist in the fact that, for the same lamp power, in continuous operation a lower lamp voltage and thus a higher lamp current and a lower optical efficiency are achieved unless measures are taken to fulfill the abovementioned functions of the mercury in some other way.

Numerous attempts to do this have already been made. However, particularly in the case of discharge lamps with a short arc (“short-arc lamps”), as required for projection displays and other applications in which a punctiform light source is necessary, these attempts have to date generally led to unsatisfactory results on account of the particular requirements for these applications.

These requirements consist essentially in that firstly high temperatures of the discharge gas of for example at least 6000 K are required for an optimal optical efficiency. For this reason, a discharge lamp should as far as possible contain no filler gases with a low ionization potential, since these have a relatively high conductivity even at low temperatures.

Furthermore, in such discharge lamps, the cross section of the electron scattering should be as large as possible, so that a relatively high lamp voltage is achieved for a given arc length.

Finally, it must also be ensured that the discharge lamp has as optimal an emission spectrum as possible in the visible region of the emitted light.

It is generally known to use xenon as a replacement for mercury. However, one disadvantage associated with xenon is that the cross section of the electron scattering is relatively small and thus the lamp voltage is also relatively low. This means that the lamp current is correspondingly high in order to achieve the high light powers necessary in particular for projection applications.

One example which may be mentioned is a known Cermax short-arc lamp with a power of 300 Watt, an arc length of 1.5 mm, a lamp voltage of 14 Volt and a lamp current of 21 Amps. In an LCD projector, such a lamp generates only approximately half the light power of a UHP lamp with a power of 120 Watt. In general, known short-arc lamps based on xenon have an efficiency which is approximately 3 to 5 times lower than that of comparable UHP lamps.

Known from US 2003/0209986 A1 is a mercury-free discharge lamp with a discharge gas which comprises a first metal halide for achieving a desired light emission (light generator), a second metal halide with a relatively high vapor pressure, which does not emit any visible light (buffer gas), and a noble gas (starter gas). It is said to be possible for this lamp also to be designed as a short-arc lamp, in order to allow use thereof in LCD projectors.

It is an object of the invention to provide an at least essentially mercury-free discharge lamp which, in particular as a short-arc lamp, has an optical efficiency which is further improved compared to known lamps of this type and also a higher lamp voltage.

Also to be provided is an at least essentially mercury-free discharge lamp by means of which an emission spectrum in the region of visible light can be generated which is particularly suitable for use in projection displays.

The object is achieved as claimed in claim 1 by a high-pressure gas discharge lamp, in particular with a short arc, which comprises a discharge vessel with an at least essentially mercury-free discharge gas which contains a noble gas and also zinc as a voltage gradient former and light generator, wherein the lamp is designed in such a way that the pressure of the zinc in the gas phase is at least approximately 20 bar in the operating state of the lamp.

By using zinc with such a high pressure, said zinc is surprisingly effective in particular as a voltage gradient former, and this was not expected previously on account of the vapor pressure thereof, which is only relatively low.

The dependent claims relate to advantageous embodiments of the invention.

Claims 2 and 3 describe a preferred pressure and a preferred type of noble gas.

Claims 4 and 5 describe various possibilities for achieving the abovementioned pressure of the zinc with a relatively low outlay.

Claim 6 relates to a wall material for the discharge vessel which is preferably to be used.

The embodiments as claimed in claims 7 and 8 have the advantage that an oxygen/halide cycle cannot occur, and as a result the service life of the lamp is considerably increased since the erosion of the electrodes is substantially reduced.

Claim 9 relates to a preferred dimensioning of the electrodes and/or of the discharge vessel which can be used to achieve a particularly high lamp voltage and efficiency of the lamp.

Finally, by means of the embodiment as claimed in claim 10, desired color properties of the emitted light can be achieved in a relatively simple manner.

The invention will be further described with reference to examples of embodiments shown in the drawing to which, however, the invention is not restricted.

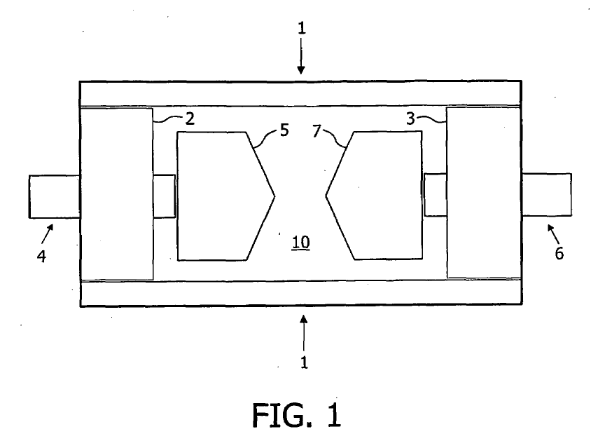

FIG. 1 shows a schematic cross section through a discharge vessel of a (second) embodiment of the invention.

The discharge lamps described below are short-arc lamps in which the arc has a length of up to approximately 4 mm and preferably in the range between approximately 1 mm and approximately 3 mm.

In a first embodiment of a mercury-free lamp according to the invention, there is located in the discharge vessel a discharge gas which contains zinc as a voltage gradient former and light generator, said zinc having a pressure in the gas phase of approximately 30 bar in the operating state of the lamp.

Also added to the discharge gas is a noble gas, preferably xenon, with a relatively high pressure of for example approximately 100 bar in the operating state of the lamp, said noble gas likewise essentially serving as a voltage gradient former at this pressure.

It has surprisingly been found that, with this gas composition and the aforementioned pressures, an arc voltage of approximately 20 Volt and a lamp voltage of approximately 32 Volt can be achieved.

This is surprising because a pure xenon lamp, even in the case of a xenon pressure of approximately 100 bar, has a lamp voltage of only approximately 17 Volt, wherein 12 Volts are caused by the voltage drop at the electrodes and the arc voltage is thus only approximately 5 Volt. An efficiency of only approximately 30% can thus be achieved, so that approximately 70% of the power supplied to the lamp does not flow into the discharge but rather is used to heat the electrodes.

With the abovementioned zinc pressure of approximately 30 bar, the efficiency of the lamp can be increased to approximately 63% and can thus be more than doubled compared to the aforementioned example of a pure xenon lamp. This value is only slightly worse than that which is achieved for a conventional UHP lamp with mercury as the voltage gradient former.

The loading of the inner wall of the discharge vessel is in this case more than 2 Watt/mm², and the arc power is more than approximately 50 Watt/mm of arc length.

Although attempts have already been made to increase the lamp voltage of a mercury-free lamp by adding zinc and zinc iodide, there was found to be a reduction in the discharge arc so that it was previously believed that an increase in the zinc/zinc iodide pressure to more than approximately 10 bar was not useful. Moreover, at a low zinc/zinc iodide pressure, only a small increase in the lamp voltage could be achieved in the case of an arc length of approximately 1.5 mm.

Preferably, the zinc is introduced into the discharge vessel only in metal form. In known mercury-containing UHP lamps, a tungsten/oxygen/halide cycle is produced by adding halogens (for example in the form of zinc iodide) and oxygen, and this cycle is said to increase the service life of the discharge lamp. However, it has been found that this measure is not successful in the case of higher zinc pressures. For this reason, in the embodiments described here, there is no addition of halides so that an oxygen/halide cycle cannot occur.

For the same reason, it has proven to be advantageous if there is also no oxygen in the discharge gas. Even if it can largely be ensured, by taking suitable measures when manufacturing the lamp, that no oxygen is contained in the discharge vessel, a very small amount of a metal which binds any oxygen present in the discharge vessel is preferably introduced. By way of example, the rare earth metals or even tantalum have proved to be particularly suitable for this purpose.

In order that a sufficient amount of zinc evaporates and the aforementioned zinc pressure is achieved, it is generally necessary that the temperature at the coldest spot in the discharge vessel does not substantially fall below a value of between approximately 1500 K and approximately 1700 K.

This may be ensured for example in a known manner by shaping the discharge vessel in an appropriate asymmetrical manner and/or by dimensioning the discharge vessel to be as small as possible and/or by dimensioning the electrodes appropriately, so that the temperature at least at the coldest spot in the discharge vessel is increased in a targeted manner.

However, since conventional wall materials for the discharge vessel, such as quartz glass in particular, are attacked at the increased temperature and may become cloudy after a relatively short period of time, the discharge vessel is made of sapphire or YAG materials which are not only suitably heat-resistant but are also optically transparent and do not scatter the emitted light or scatter it only very slightly.

A further measure which can be applied in addition or as an alternative and can be used to achieve the abovementioned evaporation and increase in pressure will be described below with reference to the second embodiment shown in FIG. 1.

FIG. 1 shows a schematic cross section through a discharge vessel 1 of a discharge lamp. On account of the heat-resistance, the abovementioned materials such as sapphire or YAG are once again used as the material for the wall of the discharge vessel 1. At the ends of the discharge vessel 1, there are known bushings 2, 3 made of glass or a ceramic material (e.g. PCA) for electrode pins 4, 6 (or connection wires), which lead to the electrodes 5, 7 arranged in the interior of the discharge vessel 1 and also serve to hold the electrodes 5, 7.

One essential feature of this discharge vessel 1 is that the ratio between the volume of the electrodes 5, 7 and the volume of the discharge chamber 10 is greater than in the case of known discharge lamps.

Preferably, the discharge vessel 1 has a conventional size and the electrodes 5, 7 have a greater volume than those in known discharge lamps.

Whereas in a known AC UHP lamp the electrodes take up for example approximately 10% and in a known DC UHP lamp they take up approximately up to 15% of the volume of the discharge chamber, in the discharge vessel 1 according to the invention the electrodes 5, 7 have a volume of more than approximately 20% in the case of an AC lamp and a volume of more than approximately 25% of the volume of the discharge chamber 10 in the case of a DC lamp.

The electrodes 5, 7 are in this case, as shown in FIG. 1, preferably configured in such a way that they have a relatively large diameter (that is to say in a direction perpendicular to the longitudinal direction of the discharge vessel), but at the same time the shape and the spacing of the opposed electrode tips is essentially retained in a known manner. In this connection, a relatively large diameter of the electrode pins 4, 6 is also advantageous since these deflect a considerable amount of the heat produced at the electrodes 5, 7 into the discharge vessel 1 and thus additionally help to heat up the latter and to achieve the abovementioned high temperatures.

Unlike the above-described first embodiment, the increase in the volume of the electrodes 5, 6 does not serve to increase the temperature in a targeted manner only at the coldest spot, but rather overall to raise the temperature in all areas of the discharge vessel 1 and at the same time to reduce the difference between the highest and the lowest temperature, so that a sufficient amount of zinc evaporates and the abovementioned pressure is achieved. It has been found that the lamp voltage can thus be increased even further, so that the second embodiment is particularly suitable for projection applications in which particularly high powers are required.

The following dimensions have proven to be particularly advantageous in this respect: the internal diameter of the discharge vessel 1 is approximately 3 mm and the internal length thereof is approximately 4 mm. The electrodes 5, 7 have a diameter of approximately 2 mm and an equivalent length of the cylindrical head of approximately 1.25 mm. The electrodes 5, 7 thus take up more than 25% of the volume of the discharge chamber 10. In the case of an external diameter of the discharge vessel 1 of approximately 7 to approximately 8 mm and a length of approximately 7 mm, the lamp is preferably operated with an input power of between approximately 150 and approximately 200 Watt. The loading on the inner wall of the discharge vessel 1 is thus more than approximately 2 W/mm².

All of the features described above, that is to say essentially both with regard to the composition and the pressure of the discharge gas and with regard to the dimensioning of the discharge vessel and of the electrodes 5, 7 as shown in FIG. 1, may be combined with one another to increase the lamp voltage and thus the efficiency of the lamp.

In order to set or optimize a desired color characteristic of the emitted light, which is particularly important when the lamp is used in projection systems, there may be added to the discharge gas, by way of example, lithium to increase the red color component, mercury to increase the blue and green color component, thallium to increase the green color component and indium to increase the blue color component. However, besides zinc, generally no other light generators are otherwise required.

With regard to the use of mercury, it should be pointed out that one significant aim of the invention is to avoid mercury in the discharge gas. This does not alter the fact that mercury may possibly also be used to correct the emission spectrum of the emitted light, since the amount of mercury used for this purpose is at least approximately 10 times less than in known lamps in which mercury is used as a voltage gradient former or buffer gas. In this respect, therefore, a lamp according to the invention which contains mercury for the purpose of correcting the emission spectrum is to be regarded as being essentially mercury-free.

Moreover, such a small amount of mercury also helps to increase the lamp voltage and thus the efficiency of the lamp.

Finally, it should also be pointed out that the above-described measures for increasing the (lowest) temperature in the discharge vessel, in particular by increasing the volume of the electrodes compared to the volume of the discharge chamber, can of course also be used in discharge lamps of other types or of the known type, which for example do not contain any zinc in the discharge gas. The increase in the volume of the electrodes is particularly useful in those lamps in which high currents flow and in which a considerable part of the energy losses are taken up by the electrodes in the form of heat.

1. A high-pressure gas discharge lamp, in particular with a short arc, comprising a discharge vessel (1) with an at least essentially mercury-free discharge gas which contains a noble gas and also zinc as a voltage gradient former and light generator, wherein the lamp is designed in such a way that the pressure of the zinc in the gas phase is at least approximately 20 bar in the operating state of the lamp.

2. A high-pressure gas discharge lamp as claimed in claim 1, in which the pressure of the noble gas lies in the region of approximately 100 bar in the operating state of the lamp.

3. A high-pressure gas discharge lamp as claimed in claim 1, in which the noble gas is xenon.

4. A high-pressure gas discharge lamp as claimed in claim 1, in which the wall loading of the lamp is increased to a value between approximately 1.5 Watt/mm² and approximately 2 Watt/mm² in order to achieve the pressure of the zinc in the gas phase.

5. A high-pressure gas discharge lamp as claimed in claim 1, in which the discharge vessel (1) and/or the electrodes (5, 7) are dimensioned and/or shaped in such a way that the lowest temperature in the discharge vessel (1) lies in the range between approximately 1500 K and approximately 1700 K.

6. A high-pressure gas discharge lamp as claimed in claim 1, in which the wall of the discharge vessel (1) is made of sapphire or YAG materials.

7. A high-pressure gas discharge lamp as claimed in claim 1, in which the discharge gas contains at least essentially no oxygen and/or at least essentially no halogen compound.

8. A high-pressure gas discharge lamp as claimed in claim 7, in which the discharge gas comprises a small amount of an oxygen-binding metal such as in particular from the group of rare earth metals or tantalum.

9. A high-pressure gas discharge lamp as claimed in claim 1, in which the electrodes (5, 7) and/or the discharge vessel (1) are dimensioned in such a way that the electrodes (5, 7) take up between at least approximately 20 and approximately 25 percent of the volume of the discharge chamber (10).

10. A high-pressure gas discharge lamp as claimed in claim 1, in which, in order to achieve desired color properties of the emitted light, the discharge gas comprises at least one substance from the following group: lithium, indium, mercury, thallium.

11. A projection system, such as in particular an LCD projection display, comprising a high-pressure gas discharge lamp as claimed in claim 1.
